(19) United States
(12) Patent Application Publication
(10) Pub. No.: US 2024/0052201 A1
(43) Pub. Date: Feb. 15, 2024

(54) METHODS AND MATERIALS FOR POLISHING OF MATERIALS

(71) Applicant: ENTEGRIS, INC., Billerica, MA (US)

(72) Inventors: Rajiv K. Singh, Newberry, FL (US); Sunny De, Gainesville, FL (US); Aditya Dilip Verma, Gainesville, FL (US)

(21) Appl. No.: 18/231,926

(22) Filed: Aug. 9, 2023

Related U.S. Application Data
(60) Provisional application No. 63/397,336, filed on Aug. 11, 2022.

(51) Int. Cl. C09G 1/02

(52) U.S. Cl. CPC C09G 1/02

(57) ABSTRACT

The present disclosure describes a slurry composition to reduce roughness a surface, such as a polycrystalline material including silicon carbide, alumina, diamond, and carbon. The present disclosure can also be applied to single crystal materials (e.g., silicon carbide, sapphire, or diamond).

### FIELD

The present disclosure relates to the field of polishing a material.

### BACKGROUND

Chemical mechanical polishing is a process of smoothing surfaces with the combination of chemical and mechanical forces.

### SUMMARY

The present disclosure describes a slurry composition to reduce roughness a surface, such as a polycrystalline material including silicon carbide, alumina, diamond, and carbon. The present disclosure can also be applied to single crystal materials (e.g., silicon carbide, sapphire, or diamond).

Polycrystalline hard materials such as silicon carbide are used in optical applications (e.g., mirrors) and for fabrication of wafer bonded single crystal silicon carbide substrates. A key requirement for all these applications is to achieve sub nanometer levels of finish. Depending on the crystallographic orientation, the hardness and the chemical activity of each grain can be different. For materials that include grains of different crystal orientation (in the micron scale), the surface finish can require improvements. Some grains polish faster than others leading to a poor finish. In some embodiments, the method of polish includes diamond lapping. However, diamond lapping can take too long for some application as well as not meet surface finish requirements. Other chemical mechanical polishing methods can lead to poor surface quality. Thus, there exists a need to develop faster and smoother polishing methods for polycrystalline silicon carbide and similar hard materials.

The present disclosure relates to a chemical mechanical polishing (CMP) slurry composition based on use of an oxidizing agent (such as an isotropic oxidizer) and a combination of particles with high aspect ratio (e.g., platy abrasive particles) combined with diamond (e.g., nano-diamond) to reduce surface roughness. Examples of platy particles included Kaolin, hydrated alumina, etc. The platy particles have one dimension, which is much thinner than the other two dimensions. The process of the present disclosure can achieve a final roughness of polished silicon carbide to be in the 4 Angstrom to 5 Angstrom range (measured on the Atomic Force Microscope) which is a factor of 2 better than some methods.

In some aspects, the techniques described herein relate to a composition including: a first particle with a first hardness; and a plurality of second particles with a second hardness at least partially surrounding the first particle, wherein the second hardness of the plurality of second particles is greater than the first hardness of the first particle, and wherein an aspect ratio of the first particle ranges from 2:1 to 1,000,000:1.

In some aspects, the techniques described herein relate to a composition, wherein a first-dimension length of the first particle is smaller than a second-dimension length of the first particle and a third-dimension length of the first particle.

In some aspects, the techniques described herein relate to a composition, wherein the first particle includes kaolin, gibbsite, aluminum bromide, alumina, quartz, boron carbide, boron nitride, boron hydride, silicon carbide, titania, boehmite, mica, magnesium hydroxide, or combinations thereof.

In some aspects, the techniques described herein relate to a composition, wherein the second particle includes diamond, silicon carbide, boron carbide, boron nitride, boron hydride, aluminum bromide, or any combinations thereof.

In some aspects, the techniques described herein relate to a composition, wherein the diamond includes an average particle size of less than 2 micron, less than 1 micron, or less than 500 nanometers.

In some aspects, the techniques described herein relate to a composition, wherein the second particle includes a particle hardness of greater than 2000 kg/mm².

In some aspects, the techniques described herein relate to a composition, wherein a pH of the composition ranges from 1 to 13.

In some aspects, the techniques described herein relate to a composition, wherein a pH of the composition ranges 1 to 3 or 11 to 13.

In some aspects, the techniques described herein relate to a composition, further including an oxidizing agent.

In some aspects, the techniques described herein relate to a composition, wherein the oxidizing agent is an isotropic oxidizer.

In some aspects, the techniques described herein relate to a composition, wherein the first particle is rod-shaped or platy-shaped.

In some aspects, the techniques described herein relate to a composition, wherein the first particle is rod-shaped, and wherein the aspect ratio of the first particle is greater than 1 or greater than 2.5.

In some aspects, the techniques described herein relate to a composition, wherein the first particle is platy-shaped, and wherein the aspect ratio of the first particle is greater than 10 or greater than 50.

In some aspects, the techniques described herein relate to a composition, wherein the composition is a slurry.

In some aspects, the techniques described herein relate to a method of using a slurry including: applying the slurry to a substrate, wherein the slurry comprises a first particle with a first hardness; and a plurality of second particles with a second hardness at least partially surrounding the first particle, wherein the second hardness of the plurality of second particles is greater than the first hardness of the first particle, and wherein an aspect ratio of the first particle ranges from 2:1 to 1,000,000:1; and polishing the substrate with the slurry until a roughness of the substrate is less than 7 angstrom.

In some aspects, the techniques described herein relate to a method, wherein a first-dimension length of the first particle is smaller than a second-dimension length of the first particle and a third-dimension length of the first particle.

In some aspects, the techniques described herein relate to a method, wherein the first particle includes kaolin, gibbsite, aluminum bromide, alumina, quartz, boron carbide, boron nitride, boron hydride, silicon carbide, titania, boehmite, mica, magnesium hydroxide, or combinations thereof.

In some aspects, the techniques described herein relate to a method, wherein the second particle includes diamond, silicon carbide, boron carbide, boron nitride, boron hydride, aluminum bromide, or any combinations thereof.

In some aspects, the techniques described herein relate to a method, wherein the diamond includes an average particle size of less than 2 micron, less than 1 micron, or less than 500 nanometers.

In some aspects, the techniques described herein relate to a method, wherein the second particle includes a particle hardness of greater than 2000 kg/mm².

In some aspects, the techniques described herein relate to a method, wherein a pH of the slurry ranges from 1 to 13.

In some aspects, the techniques described herein relate to a method, further including an oxidizing agent.

In some aspects, the techniques described herein relate to a method, wherein the oxidizing agent is an isotropic oxidizer.

In some aspects, the techniques described herein relate to a method, wherein the first particle is rod-shaped or platy-shaped.

In some aspects, the techniques described herein relate to a method, wherein the first particle is rod-shaped, and wherein the aspect ratio of the first particle is greater than 1 or greater than 2.5.

In some aspects, the techniques described herein relate to a method, wherein the first particle is platy-shaped, and wherein the aspect ratio of the first particle is greater than 10 or greater than 50.

In some aspects, the techniques described herein relate to a method, wherein the slurry is a first slurry, the method further including: applying a second slurry to the substrate before applying the first slurry.

In some aspects, the techniques described herein relate to a method, wherein polishing the substrate with the slurry includes polishing until the roughness of the substrate is less than 5 angstrom.

### DRAWINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

FIG. 1 depict a system with a slurry that includes a mixture of particles defined by a first particle with a plurality of second particles at least partially surrounding the first particle.

FIG. 2 shows an exemplary flowchart according to some of the embodiments of the methods for polishing a material (e.g., a substrate such as silicon carbide substrate).

FIG. 3A displays the polished surface for a nano-diamond-based slurry with a spherical soft-core particle.

FIG. 3B displays the polished surface for a nano-diamond-based slurry with a rod-like soft-core particle.

FIG. 3C displays the polished surface for a nano-diamond-based slurry with a platy soft-core particle.

### DETAILED DESCRIPTION

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

All prior patents and publications referenced herein are incorporated by reference in their entireties.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “between” does not necessarily require being disposed directly next to other elements. Generally, this term means a configuration where something is sandwiched by two or more other things. At the same time, the term “between” can describe something that is directly next to two opposing things. Accordingly, in any one or more of the embodiments disclosed herein, a particular structural component being disposed between two other structural elements can be:
disposed directly between both of the two other structural elements such that the particular structural component is in direct contact with both of the two other structural elements;
disposed directly next to only one of the two other structural elements such that the particular structural component is in direct contact with only one of the two other structural elements;
disposed indirectly next to only one of the two other structural elements such that the particular structural component is not in direct contact with only one of the two other structural elements, and there is another element which juxtaposes the particular structural component and the one of the two other structural elements;
disposed indirectly between both of the two other structural elements such that the particular structural component is not in direct contact with both of the two other structural elements, and other features can be disposed therebetween; or
any combination(s) thereof.

As used herein “embedded” means that a first material is distributed throughout a second material.

As used herein “slurry” means a semiliquid mixture, such as fine particles suspended in water.

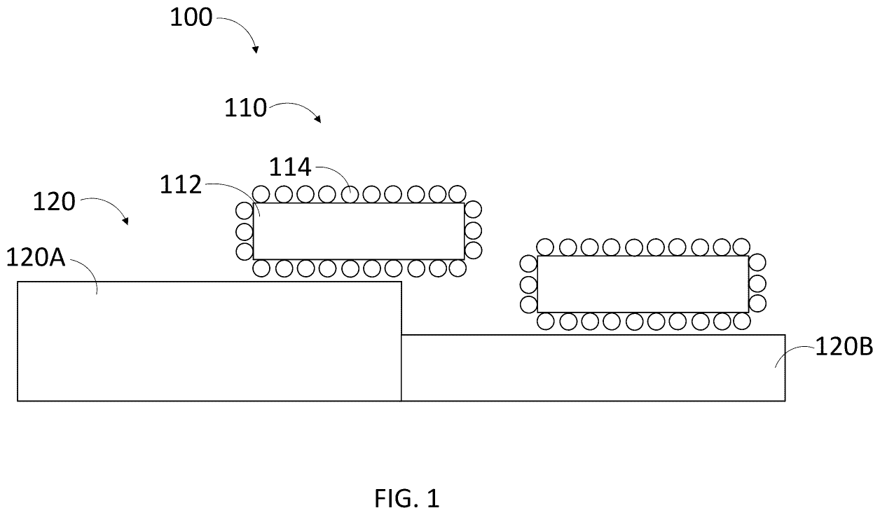

FIG. 1 depict a system 100 with a slurry 110 that includes a mixture of particles defined by a first particle 112 with a plurality of second particles 114 at least partially surrounding the first particle 112. In some embodiments, the slurry is applied to a substrate 120. In some embodiments, the substrate 120 includes a variety of grains, including a first grain 120A and a second grain 1208. The method of the present disclosure includes polishing the substrate 120 with the slurry 110 until a roughness of the substrate 120 meets a predetermined roughness threshold. For example, a predetermined threshold can be a surface of less than 7 angstroms surface finish on an atomic force microscopy (AFM) 5×5 μm scan as well as optical profilometry.

In some embodiments, the substrate 120 can have grain isotropy. For example, the substrate 120 can have anisotropic hardness for different orientations as well as anisotropic chemical reactivity. For example, the first grain 120A can be polished at a different rate than the second grain 1208. In some embodiments, the substrate 120 will have a poor surface finish (roughness) due to anisotropic polishing. The present disclosure aims to achieve a surface of less than 5 angstroms surface finish on an atomic force microscopy (AFM) 5×5 μm scan as well as optical profilometry.

In some examples, a slurry of particle (e.g., diamond particles, including nano-diamond particles) are coated on a larger spherical soft particle. This slurry provides, during polishing, for high removal rates and surface finish up to 10 angstrom surface finish. In contrast, the present disclosure uses the first particle 112 with a high aspect ratio, such as platy or rod-like structure particles, as the soft-core particle for the diamond coating. The structure of the present disclosure will polish anisotropic grains more uniformly (i.e., in reference to the structure with the large spherical particle) and can provide surface finish up to 3 angstrom to 5 angstrom.

In some embodiments, the slurry 110 includes a liquid the first particle 112 and the second particle 114 are dispersed in. The liquid can be a water-based solvent including an organic solvent such as alcohol or glycerin.

In some embodiments, the first particle 112 is kaolin, gibbsite, aluminum bromide (AlBr₃), alumina (aluminum oxide (Al₂O₃)) including alpha alumina, quartz, boron carbide (B₄C), boron nitride (BN), boron hydride (B₂H₆), silica (SiO₂), silicon carbide (SiC), titania, boehmite, mica, magnesium hydroxide (Mg(OH)₂), zirconia, ceria, or combinations thereof.

In some embodiments, kaolin is Al₂Si₂O₅(OH)₄. In some embodiments, gibbsite can be referred to as Al(OH)₃, γ-Al(OH)₃, and/or α-Al(OH)₃. In some embodiments, quartz is silica (SiO₂). In some embodiments, titania is also called titania (TiO₂). In some embodiments, boehmite is referred to as böhmite (γ-AlO(OH)). In some embodiments, mica can be given the general formula of X₂Y₄₋₆Z₈O₂₀(OH, F)₄, in which X is K, Na, or Ca or less commonly Ba, Rb, or Cs; Y is Al, Mg, or Fe or less commonly Mn, Cr, Ti, Li, etc.; Z is chiefly Si or Al, but also may include Fe³⁺ or Ti.

In some embodiments, the second particle 114 is diamond (e.g., nano-diamond), silicon carbide, boron carbide, boron nitride, boron hydride, aluminum bromide, or any combinations thereof. In some embodiments, the diamond has an average particle size of less than 5 micron, less than 4 micron, less than 3 micron, less than 2 micron, less than 1 micron, less than 500 nanometers, from 5 micron to 10 nanometers, from 4 micron to 10 nanometers, from 3 micron to 10 nanometers, from 2 micron to 10 nanometers, from 1 micron to 10 nanometers, from 500 nanometers to 10 nanometers, from 5 micron to 500 nanometers, from 5 micron to 1 micron, from 5 micron to 2 micron, from 5 micron to 3 micron, or from 5 micron to 4 micron. In some embodiments, the average particle size is measured by dynamic light scattering and sieving.

The first particle 112 has a first hardness. The second particle 114 has a second hardness. The particle hardness is determined by the Vickers hardness test. The second hardness of the second particle 114 is greater than the first hardness of the first particle 112. In some embodiments, the second particle 114 has a particle hardness of greater than 1500 kg/mm², greater than 2000 kg/mm².

The combination of the first particle 112 and the second particle 114 can be selected based on the hardness ratio between first particle 112 and the second particle 114. A selection of the first particle 112 can depend upon what the second particle 114 is. Similarly, a selection of the second particle 114 can depend upon what first particle 112 is. For example, if the first particle 112 is silica, the second particle 114 can be alumina. For example, if the second particle 114 is diamond particles, the first particle 112 can be alumina, silicon carbide and/or silica particles. For example, the first particle 112 can be alumina or silica and the second particle 114 can be boron nitride. For example, the first particle 112 can be zirconia and the second particle 114 can be diamond. For example, the first particle 112 can be silica and the second particle 114 can be silicon carbide. The second particle 114 on the first particle 112 can be attached by being physically bonded together by the difference in electrostatic charge.

The selection of the first particle 112 and the second particle 114 also depends on the substrate 120 to be polished. For example, the substrate 120 can be silicon carbide, sapphire, diamond, aluminum oxynitride, diamond, (AlON), quartz, gallium nitride, zirconia and other oxides. The substrate 120 material can be single crystal or poly-crystalline. The substrate 120 material can have more than one phase.

For the chemical aspect of the chemical mechanical polishing, the slurry 110 can also include an oxidizing agent on the first particle 112 and the second particle 114. In some embodiments, the oxidizing agent is an isotropic oxidizer. Examples of isotropic oxidizer include per-compounds, e.g., permanganate, peroxides, perchlorates, perborates, periodates, etc. Examples of isotropic oxidizer also include peroxo-compounds e.g., peroxochromates, peroxomonosulfate, peroxodisulfate, etc.

In some embodiments, the slurry 110 can include additives such as ions, alkali metals, pH modifiers, pH buffering agents, corrosion inhibitors, dispersants, anti-settling agents, or other additives. In some embodiments, a pH of the slurry is predetermined. A pH of the slurry can range from 1 to 13. In some embodiments, a pH of the composition ranges from 1 to 3 or 11 to 13. For example, a pH of the slurry 110 can be determined based on the material of the substrate 120. For example, when the substrate 120 is sapphire alumina, the pH of the slurry 110 can be greater than 12. In some examples, when the substrate 120 is silicon carbide, the pH of the slurry 110 can be less than 3 or greater than 12.

In some embodiments, an aspect ratio of the first particle 112 can range from 2:1 to 1,000,000:1, from 50,000:1 to 1,000,000:1, from 100,000 to 1,000,000:1, from 150,000 to 1,000,000:1, from 200,000 to 1,000,000:1, from 250,000 to 1,000,000:1, from 300,000 to 1,000,000:1, from 350,000 to 1,000,000:1, from 400,000 to 1,000,000:1, from 450,000 to 1,000,000:1, from 500,000 to 1,000,000:1, from 550,000 to 1,000,000:1, from 600,000 to 1,000,000:1, from 650,000 to 1,000,000:1, from 700,000 to 1,000,000:1, from 750,000 to 1,000,000:1, from 800,000 to 1,000,000:1, from 850,000 to 1,000,000:1, from 900,000 to 1,000,000:1, from 950,000 to 1,000,000:1, 2:1 to 950,000:1, 2:1 to 900,000:1, 2:1 to 850,000:1, 2:1 to 800,000:1, 2:1 to 750,000:1, 2:1 to 700,000:1, 2:1 to 650,000:1, 2:1 to 600,000:1, 2:1 to 550,000:1, 2:1 to 500,000:1, 2:1 to 450,000:1, 2:1 to 400,000:1, 2:1 to 350,000:1, 2:1 to 300,000:1, 2:1 to 250,000:1, 2:1 to 200,000:1, 2:1 to 150,000:1, 2:1 to 100,000:1, or 2:1 to 50,000:1.

In some embodiments, a first-dimension length of the first particle 112 is smaller than a second-dimension length of the first particle 112 and a third-dimension length of the first particle 112. In some embodiments, the first particle 112 can be rod-shaped. A rod may be defined as two-dimensional particle with an aspect ratio greater than 0.5, greater than 1, greater than 1.5, greater than 2, greater than 2.5, greater than 3, or greater than 3.5. In some embodiments, the first particle 112 can be platy shaped. A platy can be defined as a two-dimensional particle with an aspect ratio greater than 10, greater than 20, greater than 30, greater than 40, greater than 50, or greater than 60.

In some embodiments, the first particle 112 and the second particle 114 can be selected on the basis of their crystal structure as well. In some embodiments, the crystal structure of the first particle 112 and the second particle 114 can be monoclinic, triclinic, and/or hexagonal.

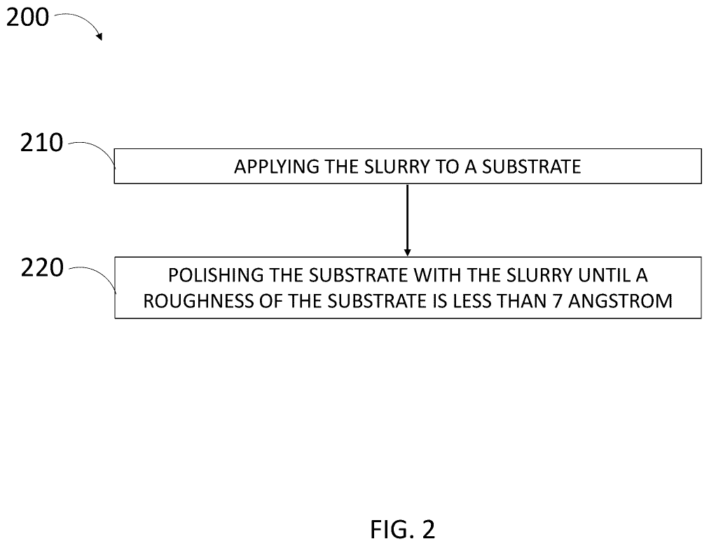

FIG. 2 shows an exemplary flowchart according to some of the embodiments of the methods for polishing a material (e.g., a substrate such as silicon carbide substrate). The slurry can be any of the embodiments described herein. The method 200 includes applying 210 the slurry to a substrate. The method 200 includes polishing 220 the substrate with the slurry until a roughness of the substrate is less than 7 angstrom.

### EXAMPLES

### Example 1

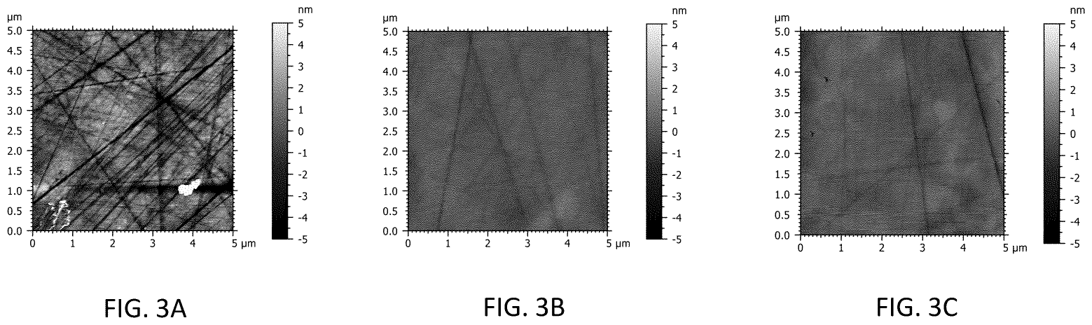

FIG. 3A displays the polished surface for a nano-diamond-based slurry with a spherical soft-core particle. The removal rate was approximately 12 μm/hr. The resultant surface finish was approximately 10 angstroms.

### Example 2

FIG. 3B displays the polished surface for a nano-diamond-based slurry with a rod-like soft-core particle. The removal rate was approximately 4 μm/hr. The resultant surface finish was approximately 3 angstroms.

### Example 3

FIG. 3C displays the polished surface for a nano-diamond-based slurry with a platy soft-core particle. The removal rate was approximately 5 μm/hr. The resultant surface finish was approximately 4 angstroms.

### ASPECTS

Various Aspects are described below. It is to be understood that any one or more of the features recited in the following Aspect(s) can be combined with any one or more other Aspect(s).

Aspect 1. A composition comprising: a first particle with a first hardness; and a plurality of second particles with a second hardness at least partially surrounding the first particle, wherein the second hardness of the plurality of second particles is greater than the first hardness of the first particle, and wherein an aspect ratio of the first particle ranges from 2:1 to 1,000,000:1.

Aspect 2. The composition of Aspect 1, wherein a first-dimension length of the first particle is smaller than a second-dimension length of the first particle and a third-dimension length of the first particle.

Aspect 3. The composition of Aspect 1 or Aspect 2, wherein the first particle comprises kaolin, gibbsite, aluminum bromide, alumina, quartz, boron carbide, boron nitride, boron hydride, silicon carbide, titania, boehmite, mica, magnesium hydroxide, or combinations thereof.

Aspect 4. The composition as in any of the preceding Aspects, wherein the second particle comprises diamond, silicon carbide, boron carbide, boron nitride, boron hydride, aluminum bromide, or any combinations thereof.

Aspect 5. The composition of Aspect 4, wherein the diamond comprises an average particle size of less than 2 micron, less than 1 micron, or less than 500 nanometers.

Aspect 6. The composition of Aspect 4, wherein the second particle comprises a particle hardness of greater than 2000 kg/mm².

Aspect 7. The composition as in any of the preceding Aspects, wherein a pH of the composition ranges from 1 to 13.

Aspect 8. The composition as in any of the preceding Aspects, wherein a pH of the composition ranges 1 to 3 or 11 to 13.

Aspect 9. The composition as in any of the preceding Aspects, further comprising an oxidizing agent.

Aspect 10. The composition of Aspect 9, wherein the oxidizing agent is an isotropic oxidizer.

Aspect 11. The composition as in any of the preceding Aspects, wherein the first particle is rod-shaped or platy-shaped.

Aspect 12. The composition of Aspect 11, wherein the first particle is rod-shaped, and wherein the aspect ratio of the first particle is greater than 1 or greater than 2.5.

Aspect 13. The composition of Aspect 11, wherein the first particle is platy-shaped, and wherein the aspect ratio of the first particle is greater than 10 or greater than 50.

Aspect 14. The composition as in any of the preceding Aspects, wherein the composition is a slurry.

Aspect 15. A method of using a slurry comprising: applying the slurry to a substrate, wherein the slurry comprises a first particle with a first hardness; and a plurality of second particles with a second hardness at least partially surrounding the first particle, wherein the second hardness of the plurality of second particles is greater than the first hardness of the first particle, and wherein an aspect ratio of the first particle ranges from 2:1 to 1,000,000:1; and polishing the substrate with the slurry until a roughness of the substrate is less than 7 angstrom.

Aspect 16. The method of Aspect 15, wherein a first-dimension length of the first particle is smaller than a second-dimension length of the first particle and a third-dimension length of the first particle.

Aspect 17. The method of Aspect 15 or Aspect 16, wherein the first particle comprises kaolin, gibbsite, aluminum bromide, alumina, quartz, boron carbide, boron nitride, boron hydride, silicon carbide, titania, boehmite, mica, magnesium hydroxide, or combinations thereof.

Aspect 18. The method as in any of the preceding Aspects, wherein the second particle comprises diamond, silicon carbide, boron carbide, boron nitride, boron hydride, aluminum bromide, or any combinations thereof.

Aspect 19. The method of Aspect 18, wherein the diamond comprises an average particle size of less than 2 micron, less than 1 micron, or less than 500 nanometers.

Aspect 20. The method of Aspect 18, wherein the second particle comprises a particle hardness of greater than 2000 kg/mm².

Aspect 21. The method as in any of the preceding Aspects, wherein a pH of the slurry ranges from 1 to 13.

Aspect 22. The method as in any of the preceding Aspects, further comprising an oxidizing agent.

Aspect 23. The method of Aspect 22, wherein the oxidizing agent is an isotropic oxidizer.

Aspect 24. The method as in any of the preceding Aspects, wherein the first particle is rod-shaped or platy-shaped.

Aspect 25. The method of Aspect 24, wherein the first particle is rod-shaped, and wherein the aspect ratio of the first particle is greater than 1 or greater than 2.5.

Aspect 26. The method of Aspect 24, wherein the first particle is platy-shaped, and wherein the aspect ratio of the first particle is greater than 10 or greater than 50.

Aspect 27. The method as in any of the preceding Aspects, wherein the slurry is a first slurry, the method further comprising: applying a second slurry to the substrate before applying the first slurry.

Aspect 28. The method as in any of the preceding Aspects, wherein polishing the substrate with the slurry comprises polishing until the roughness of the substrate is less than 5 angstrom.

It is to be understood that changes may be made in detail, especially in matters of the construction materials employed and the shape, size, and arrangement of parts without departing from the scope of the present disclosure. This Specification and the embodiments described are examples, with the true scope and spirit of the disclosure being indicated by the claims that follow.

What is claimed is:

1. A composition comprising:
a first particle with a first hardness; and
a plurality of second particles with a second hardness at least partially surrounding the first particle,
wherein the second hardness of the plurality of second particles is greater than the first hardness of the first particle, and
wherein an aspect ratio of the first particle ranges from 2:1 to 1,000,000:1.

2. The composition of claim 1, wherein a first-dimension length of the first particle is smaller than a second-dimension length of the first particle and a third-dimension length of the first particle.

3. The composition of claim 1, wherein the first particle comprises kaolin, gibbsite, aluminum bromide, alumina, quartz, boron carbide, boron nitride, boron hydride, silicon carbide, titania, boehmite, mica, magnesium hydroxide, or combinations thereof.

4. The composition of claim 1, wherein the second particle comprises diamond, silicon carbide, boron carbide, boron nitride, boron hydride, aluminum bromide, or any combinations thereof.

5. The composition of claim 4, wherein the diamond comprises an average particle size of less than 2 micron, less than 1 micron, or less than 500 nanometers.

6. The composition of claim 4, wherein the second particle comprises a particle hardness of greater than 2000 kg/mm².

7. The composition of claim 1, wherein a pH of the composition ranges from 1 to 13.

8. The composition of claim 1, wherein a pH of the composition ranges 1 to 3 or 11 to 13.

9. The composition of claim 1, further comprising an oxidizing agent.

10. The composition of claim 9, wherein the oxidizing agent is an isotropic oxidizer.

11. The composition of claim 1, wherein the first particle is rod-shaped or platy-shaped.

12. The composition of claim 11,
wherein the first particle is rod-shaped, and
wherein the aspect ratio of the first particle is greater than 1 or greater than 2.5.

13. The composition of claim 11,
wherein the first particle is platy-shaped, and
wherein the aspect ratio of the first particle is greater than 10 or greater than 50.

14. The composition of claim 1, wherein the composition is a slurry.

15. A method of using a slurry comprising:
applying the slurry to a substrate, wherein the slurry comprises
a first particle with a first hardness; and
a plurality of second particles with a second hardness at least partially surrounding the first particle,
wherein the second hardness of the plurality of second particles is greater than the first hardness of the first particle, and
wherein an aspect ratio of the first particle ranges from 2:1 to 1,000,000:1; and
polishing the substrate with the slurry until a roughness of the substrate is less than 7 angstrom.

16. The method of claim 15, wherein a first-dimension length of the first particle is smaller than a second-dimension length of the first particle and a third-dimension length of the first particle.

17. The method of claim 15, wherein the first particle comprises kaolin, gibbsite, aluminum bromide, alumina, quartz, boron carbide, boron nitride, boron hydride, silicon carbide, titania, boehmite, mica, magnesium hydroxide, or combinations thereof.

18. The method of claim 15, wherein the second particle comprises diamond, silicon carbide, boron carbide, boron nitride, boron hydride, aluminum bromide, or any combinations thereof.

19. The method of claim 18, wherein the diamond comprises an average particle size of less than 2 micron, less than 1 micron, or less than 500 nanometers.

20. The method of claim 18, wherein the second particle comprises a particle hardness of greater than 2000 kg/mm².

21. The method of claim 15, wherein a pH of the slurry ranges from 1 to 13.

22. The method of claim 15, further comprising an oxidizing agent.

23. The method of claim 22, wherein the oxidizing agent is an isotropic oxidizer.

24. The method of claim 15, wherein the first particle is rod-shaped or platy-shaped.

25. The method of claim 24,
wherein the first particle is rod-shaped, and
wherein the aspect ratio of the first particle is greater than 1 or greater than 2.5.

26. The method of claim 24,
wherein the first particle is platy-shaped, and
wherein the aspect ratio of the first particle is greater than 10 or greater than 50.

27. The method of claim 15, wherein the slurry is a first slurry, the method further comprising: applying a second slurry to the substrate before applying the first slurry.

28. The method of claim 15, wherein polishing the substrate with the slurry comprises polishing until the roughness of the substrate is less than 5 angstrom.
